(19) United States
(12) Patent Application Publication
(10) Pub. No.: US 2015/0085361 A1
(43) Pub. Date: Mar. 26, 2015

(54) TELESCOPE COMPRISING AN ACTIVE MIRROR AND INTERNAL MEANS FOR MONITORING SAID ACTIVE MIRROR

(71) Applicant: THALES, Neuilly Sur Seine (FR)

(72) Inventors: Jean-Francois BLANC, MANDELIEU (FR); Kamel HOUAIRI, CANNES (FR); Marc BERNOT, CANNES LA BOCCA (FR); Stephane GARIN, LA ROQUETTE SUR SIAGNES (FR)

(21) Appl. No.: 14/488,957

(22) Filed: Sep. 17, 2014

(30) Foreign Application Priority Data
Sep. 20, 2013 (FR) 1302187

(51) Int. Cl. G02B 23/00

(52) U.S. Cl. CPC G02B 23/145
USPC 359/422

(57) ABSTRACT

The general field provided is that of telescopes comprising an optical system and wavefront-analyzing placed in the focal plane of the optical system. The optical system comprises focusing optics and magnifying optics, the magnifying optics comprising a deformable mirror, the deformation of which is controllable. The telescope comprises monitoring the deformable mirror, comprising a source placed so that the image of the source, after reflection from the deformable mirror, is focused on the wavefront-analyzing. The monitoring comprises a movable mirror having two positions, a rest position and a monitoring position. The source may either be placed in the intermediate focal plane of the focusing optics, or at the focal point of a monitoring mirror, or even in the vicinity of the focal plane of the optical system.

### CROSS-REFERENCE TO RELATED APPLICATION

This application claims priority to foreign French patent application No. FR 1302187, filed on Sep. 20, 2013, the disclosure of which is incorporated by reference in its entirety.

### FIELD OF THE INVENTION

The general field of the invention is that of telescopes comprising a primary mirror and an active mirror for correcting defects in the primary mirror.

### BACKGROUND

A telescope conventionally comprises a primary mirror that may be large in size, and corrector optics that may comprise a number of mirrors and that form, from the intermediate image at the focal point of the primary mirror, a secondary image on a photodetector. In a certain number of applications, the corrector optics comprise a deformable mirror allowing defects in the primary mirror to be corrected. Thus it is possible to correct continuously defects due, for example, to temperature variations.

The deformable mirror comprises actuators that allow its surface to be deformed according to a preset law. It is essential, between two corrections of the primary mirror, for the deformation applied to the deformable mirror to be perfectly stable. The order of magnitude of the required stability is about 5 nanometers. However, for certain types of space telescope, the length of time between two successive corrections may be very large, about one month. It will be understood that it is difficult to guarantee such a high stability over such long periods of time.

Means allowing the surface of a deformable mirror M to be monitored do exist. It is possible, for example, as shown in FIG. 1, to use an interferometer I that is dedicated to this monitoring task and that functions at a different incidence to that used for the deformable mirror M. However, integration of such means is not necessarily simple. Now, active telescopes comprise internal means allowing the overall quality of their optics to be monitored. These means generally comprise a wavefront analyzer.

### SUMMARY OF THE INVENTION

The telescope according to the invention makes use of these means, adapting them to also monitor the deformable mirror alone.

More precisely, the subject of the invention is a telescope comprising at least one optical system and wavefront-analyzing means placed in the focal plane of said optical system, the optical system comprising focusing optics and magnifying optics, the magnifying optics comprising a deformable mirror, the deformation of which is controllable, characterized in that the telescope comprises means for monitoring the deformable mirror, said monitoring means comprising a source placed so that the image of said source, after reflection from, at least, the deformable mirror, is focused on the wavefront-analyzing means.

Advantageously, the source is placed in the intermediate focal plane of the focusing optics.

Advantageously, an aberration corrector is implanted by the source or by the wavefront-analyzing means.

Advantageously, the monitoring means comprise a movable mirror having two fixed positions, the first fixed position being located outside of the optical system, the monitoring second fixed position being such that the movable mirror masks all or some of the radiation issued from the focusing optics, the image of the source, after reflection at least from the deformable mirror and the movable mirror, being focused on the wavefront-analyzing means.

Advantageously, the movable mirror is a spherical concave mirror, the source being placed in the vicinity of the focal plane of the optical system.

Advantageously, the monitoring means comprise a fixed mirror located outside of the optical system and arranged so that, the movable mirror being placed in its second position, the image of the source, after reflection at least from the deformable mirror, the movable mirror and the fixed mirror, is focused on the wavefront-analyzing means.

Advantageously, the movable mirror is a plane mirror and the fixed mirror a concave mirror that may, for example, be elliptical.

Advantageously, the source is placed in the vicinity of the focal plane of the optical system.

Advantageously, the fixed mirror is a concave mirror, an elliptical concave mirror for example, the source, preferably a point source, being placed at the focal point of said mirror.

Advantageously, the focusing optics comprises a concave primary mirror and a convex secondary mirror.

Advantageously, the magnifying optics comprises the deformable mirror, the deformation of which is controllable, and at least one plane mirror.

### BRIEF DESCRIPTION OF THE DRAWINGS

The invention will be better understood and other advantages will become apparent on reading the following description given by way of nonlimiting example and with reference to the appended figures, in which:

FIG. 1 shows means for monitoring a deformable mirror according to the prior art;

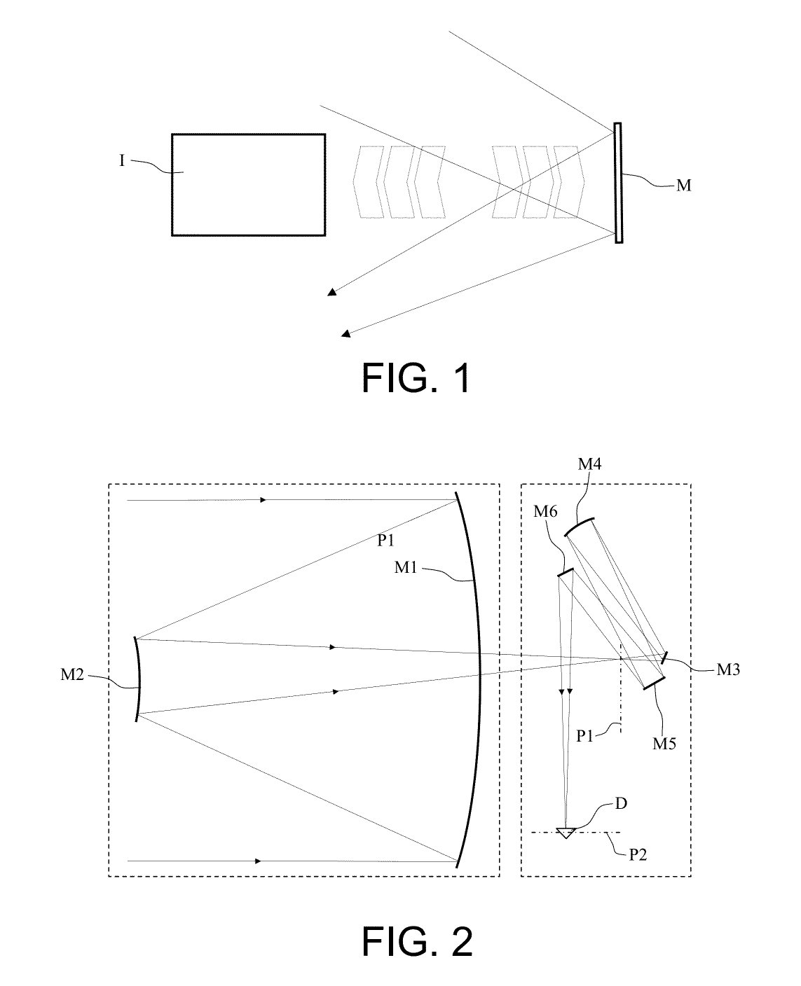

FIG. 2 shows the optics of a telescope comprising a deformable mirror, according to the prior art;

FIGS. 3, 4, 5 and 6 show four embodiments of monitoring means of a telescope according to the invention; and

FIG. 7 shows an example of an aberration pattern at the intermediate focal point of a telescope.

### DETAILED DESCRIPTION

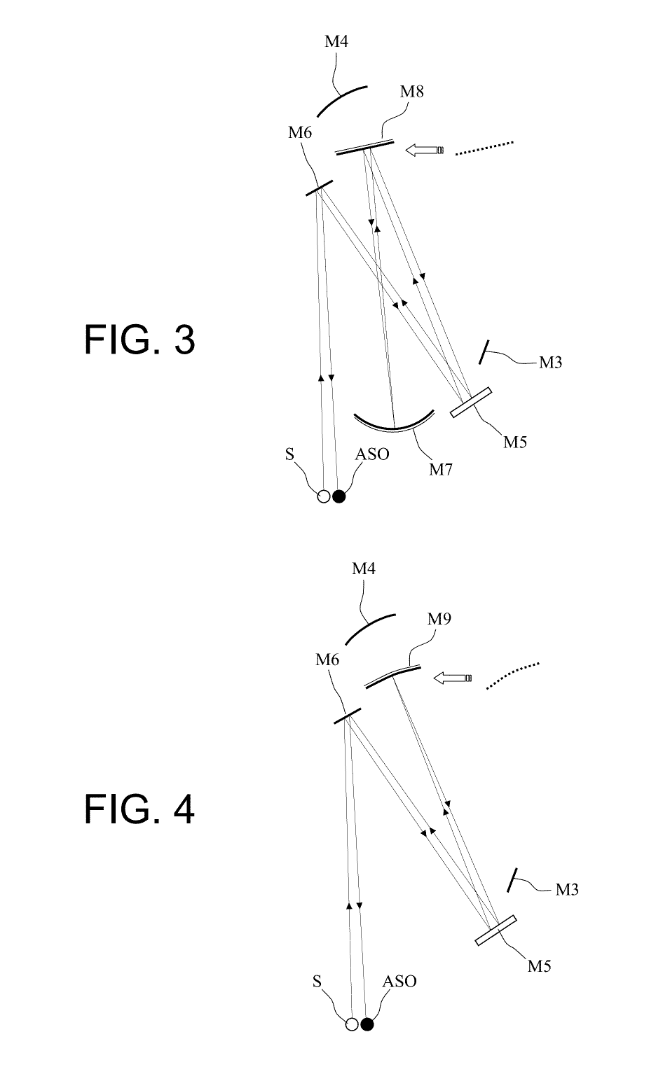

By way of example, FIG. 2 shows the optics of a telescope not comprising optical monitoring means. It essentially comprises two portions that include, on the one hand, focusing optics, and on the other hand, magnifying optics. The focusing optics comprises a first large parabolic concave mirror M1 and a convex mirror M2, these two mirrors together forming, for an object at infinity, an image in their intermediate focal plane P1.

The magnifying optics comprises four mirrors referenced M3, M4, M5 and M6 folded into a compact structure. The mirrors M3 and M6 are plane mirrors, the mirror M4 is an aspherical concave mirror. The mirror M5 is a substantially plane deformable mirror, the deformation of which is controllable, i.e. it is a mirror the shape of which is controllable by actuators. A detector D is placed in the focal plane of the telescope P2. This detector performs wavefront analysis. It may be a dedicated wavefront analyzer or a mission detector used for wavefront analysis.

The object of the invention is to place, in the above magnifying optics, monitoring means that make it possible to verify the optical quality of the deformable mirror. For this purpose, the monitoring means comprise a source placed so that the image of the source, after reflection from the deformable mirror, is focused on the wavefront-analyzing means. The source may be placed directly in the magnifying optics. An optical fiber may also allow it to be located remotely. This source may be a point or quasi-point source.

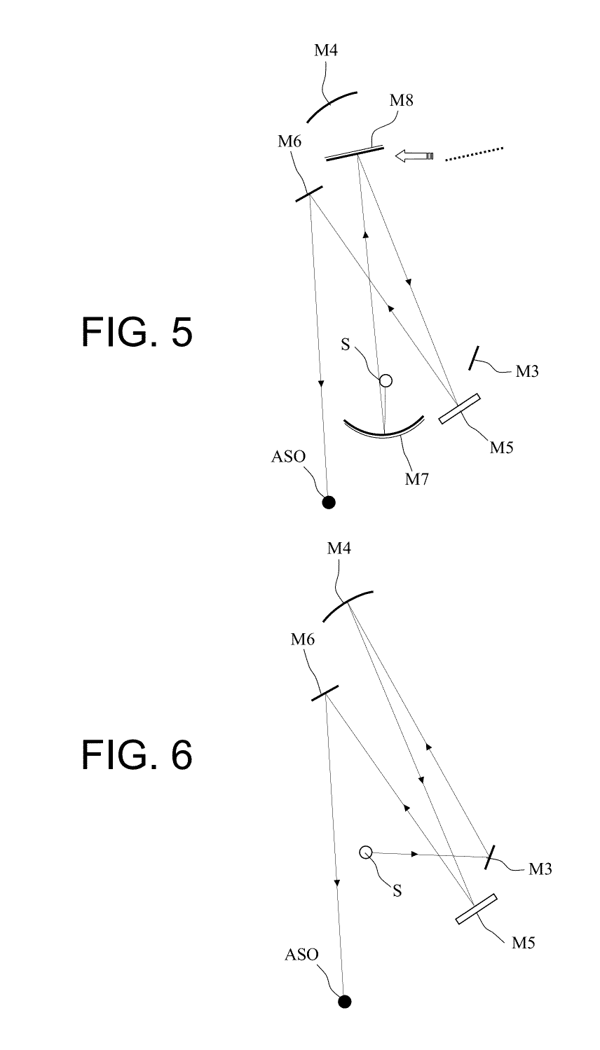

By way of example, four possible embodiments of the monitoring means are shown in FIGS. 3 to 6. In these various figures, the source S is represented by a white circle, the wavefront-analyzing means ASO by a black circle, light rays issued from the source by arrowed lines and optical means specific to the monitoring by double lines.

FIG. 3 shows a first embodiment. In this example, the monitoring means comprise a spherical concave mirror M7 and a movable plane mirror M8 that is able to occupy two positions. The source S is placed in the vicinity of the focal plane of the telescope. In a first “rest” position, the mirror M8 is placed outside of the optical system of the telescope, it is shown by the dotted lines in FIG. 3, the deformable mirror M5 is not monitored and the source S is turned off.

In a second position referred to as the “monitoring” position, the mirror M8 is moved in front of the steering mirror M4. The source S is turned on. The arrangement of the mirrors M5, M6, M7 and M8 is such that the image of the source S, via reflection from M5, M6, M7 and M8 in succession, is located on the wavefront-analyzing means ASO. All that is required is to correctly choose the location of the mirrors M7 and M8, their inclination and the curvature of the spherical mirror M7.

In a first variant embodiment shown in FIG. 4, the fixed mirror M7 is removed and the movable plane mirror M8 is replaced by a movable spherical mirror M9. The source S remains placed in the vicinity of the focal plane of the telescope. The arrangement of the mirrors M5, M6 and M9 is such that the image of the source S, via reflection from M5, M6 and M9 in succession, is located on the wavefront-analyzing means ASO. All that is required is to correctly choose the location, inclination and the curvature of the spherical mirror M9.

In a second variant embodiment shown in FIG. 5, the concave mirror M7 and the movable plane mirror M8 are preserved but the source S is placed at the focal point of the mirror M7, which may be a parabolic mirror. It is possible to replace the parabolic mirror with a lens, the source S then being located at the focal point of this lens. The arrangement of the mirrors M5, M6, M7 and M8 is such that the image of the source S, via reflection from M5, M6, M7 and M8 in succession, is located on the wavefront-analyzing means ASO. All that is required is to correctly choose the location of the mirrors M7 and M8, their inclination and the curvature of the spherical mirror M7.

The above embodiments require a movable mirror to be used, which must be positionable, in the monitoring position, with a high degree of orientational precision, if it is a question of a plane mirror, and with a high degree of orientational and positional precision, if it is a question of a concave mirror with an optical power. Thus, in a last embodiment, shown in FIG. 6, the monitoring means simply comprise a source S placed in the vicinity of the intermediate focal point and in the vicinity of the field of the wavefront-analyzing detector. The image pattern of the source S is aberrant because it is placed upstream of the mirror M4 that corrects the aberrations of the main telescope made up of the mirrors M1 and M2.

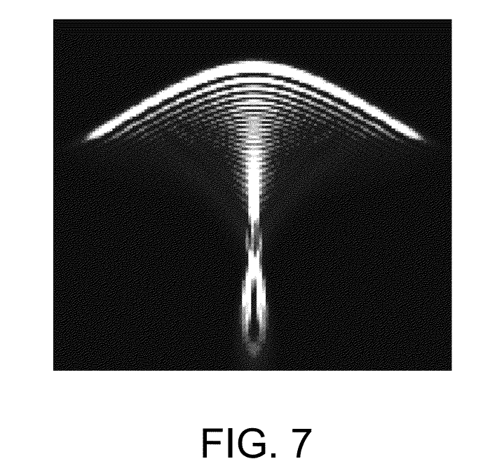

This in no way adversely affects measurement of the deformable mirror, which may be measured just as well with an aberrant image. An example of the shape of an aberrant image pattern in the focal plane of the instrument is given in FIG. 7. The pattern in FIG. 7 has a symmetrical tuft shape, the fringes of which are due to diffraction.

Advantageously, a correcting element, for example a phase plate, may be provided in order to decrease the aberration and limit the spreading of the pattern acquired by the wavefront analyzer. This correcting element may either be placed at the entrance of the wavefront analyzer or on a steering mirror by the source.

The optical field of the wavefront-analyzing detector must be slightly larger than normal in order to pass both the image issued from the telescope and the image of the source.

The latter solution has the advantages of requiring only minor changes to the optics of the telescope, and of not requiring any mirrors to be moved and of allowing the deformable mirror to be continuously followed.

1. A telescope comprising at least one optical system and wavefront-analyzing means placed in the focal plane of said optical system, the optical system comprising focusing optics and magnifying optics, the magnifying optics comprising a deformable mirror, the deformation of which is controllable, wherein the magnifying optics comprises a single concave mirror and two plane mirrors, and in that the telescope comprises means for monitoring the deformable mirror, said monitoring means comprising a source placed so that the image of said source, after reflection from, at least, the deformable mirror, is focused on the wavefront-analyzing means placed in the focal plane of the telescope.

2. The telescope as claimed in claim 1, wherein the source is placed in the intermediate focal plane of the focusing optics.

3. The telescope as claimed in claim 2, wherein an aberration corrector is implanted by the source or by the wavefront-analyzing means.

4. The telescope as claimed in claim 1, wherein the monitoring means comprise a movable mirror having two fixed positions, the first fixed position being located outside of the optical system, the monitoring second fixed position being such that the movable mirror masks all or some of the radiation issued from the focusing optics, the image of the source, after reflection at least from the deformable mirror and the movable mirror, being focused on the wavefront-analyzing means.

5. The telescope as claimed in claim 4, wherein the movable mirror is a concave mirror, the source being placed in the vicinity of the focal plane of the optical system.

6. The telescope as claimed in claim 5, wherein the concave movable mirror is elliptical.

7. The telescope as claimed in claim 4, wherein the monitoring means comprise a fixed mirror located outside of the optical system and arranged so that, the movable mirror being placed in its second position, the image of the source, after reflection at least from the deformable mirror, the movable mirror and the fixed mirror, is focused on the wavefront-analyzing means.

8. The telescope as claimed in claim 7, wherein the movable mirror is a plane mirror and the fixed mirror a concave mirror.

9. The telescope as claimed in claim 8, wherein the concave fixed mirror is elliptical.

10. The telescope as claimed in claim 8, wherein the source is placed in the vicinity of the focal plane of the optical system.

11. The telescope as claimed in claim 8, wherein the source is placed at the focal point of said concave mirror.

12. The telescope as claimed in claim 1, wherein the focusing optics comprises a concave primary mirror and a convex secondary mirror.

13. The telescope as claimed in claim 1, wherein the concave mirror of the magnifying optics is aspherical.
